(19) United States
(12) Patent Application Publication
(10) Pub. No.: US 2023/0335082 A1
(43) Pub. Date: Oct. 19, 2023

(54) KEYBOARD INSTRUMENT STAND AND KEYBOARD INSTRUMENT SET

(71) Applicant: CASIO COMPUTER CO., LTD., Tokyo (JP)

(72) Inventors: Shigeyuki NAGATSUMA, Tokyo (JP); Hirokatsu KATOH, Kawasaki-shi (JP); Takahiro MORIYA, Tokyo (JP)

(73) Assignee: CASIO COMPUTER CO., LTD., Tokyo (JP)

(21) Appl. No.: 18/131,334

(22) Filed: Apr. 5, 2023

(30) Foreign Application Priority Data
Apr. 14, 2022 (JP) 2022-066719

(51) Int. Cl. G10C 3/26; G10C 3/04; G10C 3/12

(52) U.S. Cl. CPC G10C 3/26; G10C 3/04; G10C 3/12

(57) ABSTRACT

A keyboard instrument stand for a keyboard instrument set includes a leg portion configured to support a keyboard instrument, a pedal device, and a pedal frame configured to fix the pedal device of which at least a part is disposed further backwards than a backmost end portion in a short direction of the keyboard instrument.

### CROSS-REFERENCE TO RELATED APPLICATION

This patent application is based upon and claims the benefit of priority under 35 USC 119 of Japanese Patent Application No. 2022-066719 filed on Apr. 14, 2022, the entire disclosure of which, including the specification, claims, drawings and abstract, is incorporated herein by reference in its entirety.

### BACKGROUND

### Technical Field

The present disclosure relates to a keyboard instrument stand and a keyboard instrument set.

### Description of the Related Art

There have conventionally been disclosed keyboard instrument sets including a pedal device for bringing about a damper effect and the like and a leg portion for supporting a keyboard instrument. Japanese Unexamined Patent Application Publication No. 2008-3493 (JP-A-2008-3493) discloses an example of such a keyboard instrument.

### SUMMARY

According to an aspect of the present disclosure, there is provided a keyboard instrument stand including a leg portion configured to support a keyboard instrument, a pedal device, and a pedal frame configured to fix the pedal device of which at least a part is disposed further backwards than a backmost end portion in a short direction of the keyboard instrument.

According to another aspect of the present disclosure, there is provided a keyboard instrument set including a keyboard instrument and the keyboard instrument stand.

### BRIEF DESCRIPTION OF THE DRAWINGS

FIG. 1 is a perspective view of a keyboard instrument set according to an embodiment of the present disclosure, as viewed obliquely downwards from an upper side on a right-hand side thereof;

FIG. 2 is a perspective of a keyboard instrument stand according to the embodiment of the present disclosure, as viewed obliquely downwards from an upper site on a right-hand side thereof;

FIG. 3 is a perspective view of the keyboard instrument set according to the embodiment of the present disclosure, as viewed obliquely upwards from a lower side on a left-hand side thereof;

FIG. 4 is a plan view of the keyboard instrument set according to the embodiment of the present disclosure, as viewed from a directly upper side thereof;

FIG. 5 is a front view of the keyboard instrument set according to the embodiment of the present disclosure, as viewed directly from a front side thereof;

FIG. 6 is a right side view of the keyboard instrument set according to the embodiment of the present disclosure, showing a state in which, the keyboard instrument set is set by the side of a wall; and

FIG. 7 is a right side view of the keyboard instrument set according to the embodiment of the present disclosure, showing a state in which, the keyboard instrument set falls down to a back side thereof.

### DESCRIPTION OF THE EMBODIMENT

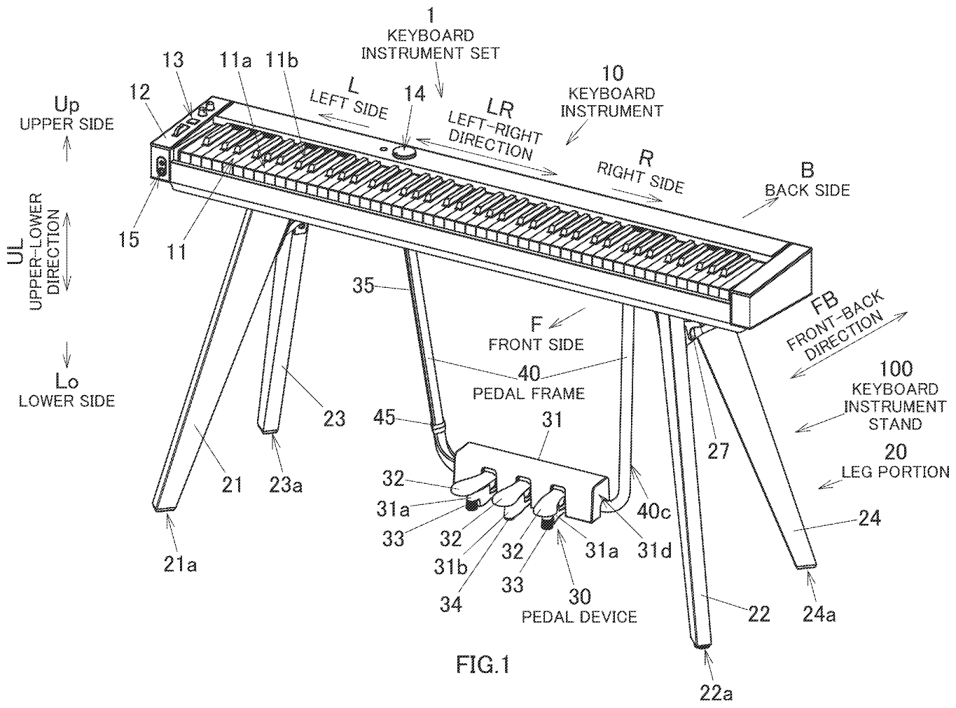

Hereinafter, an embodiment of the present disclosure will be described based on drawings. A keyboard instrument set 1 shown in FIGS. 1 to 5 includes a keyboard instrument 10 and a keyboard instrument stand 100. The keyboard instrument stand 100 includes a leg portion 20, a pedal device 30, and pedal frames 40. The keyboard instrument 10 includes a full-scale (88-note) keyboard 11 including plural white keys 11a and plural black keys 11b, which make up a large number of keys or 88 keys of the keyboard 11, and a case 12. In the following description, a direction of a front and a back to the keys in the keyboard 11 is referred to as a front-back direction FB. The front to the keys in the keyboard 11 is referred to as a front side F (a player's side), while the back to the keys in the keyboard 11 is referred to as a back side B. When facing the keyboard 11 from the front side F, a left of the keyboard 11 is referred to as a left side L, while a right of the keyboard 11 is referred to as a right side R. An alignment direction of the keys in the keyboard 11 is referred to as a left-right direction LR. In addition, when viewing the keyboard instrument 10 in an upper-lower direction UL thereof, an upper side is referred to as an upper side Up, while a lower side is referred to as a lower side Lo. In the present embodiment, while the keyboard instrument 10 is described as an electronic piano, the present disclosure may be applied to any other keyboard instruments as long as they are a musical instrument configured to sound notes in response to key depressing operations by a player (a user).

A control section 13 including a volume control dial, various buttons, and the like is provided on an upper surface of a portion at a left side L of the case 12 of the keyboard instrument 10. A control section 14 including a rotary knob and the like is also provided on an upper surface of a portion of the case 12 which lies slightly closer to the left side L than a center of the case 12. In addition, an earphone jack 15 is provided in a front surface of the portion at the left side L of the case 12. A terminal panel 16, into which plugs and jacks of various pieces of wiring such as a power supply plug are inserted, is provided on a back surface (a back surface 12b) of the case 12 of the keyboard instrument 10 substantially at a central lower side of the back surface. A substrate to which a jack is attached is provided inside the keyboard instrument 10. A data communication portion for communication with outside equipment includes this substrate.

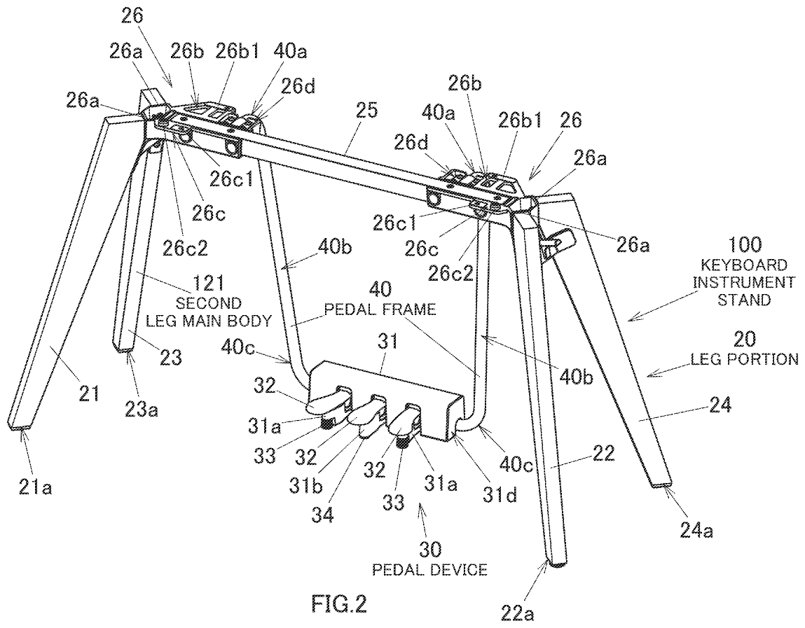

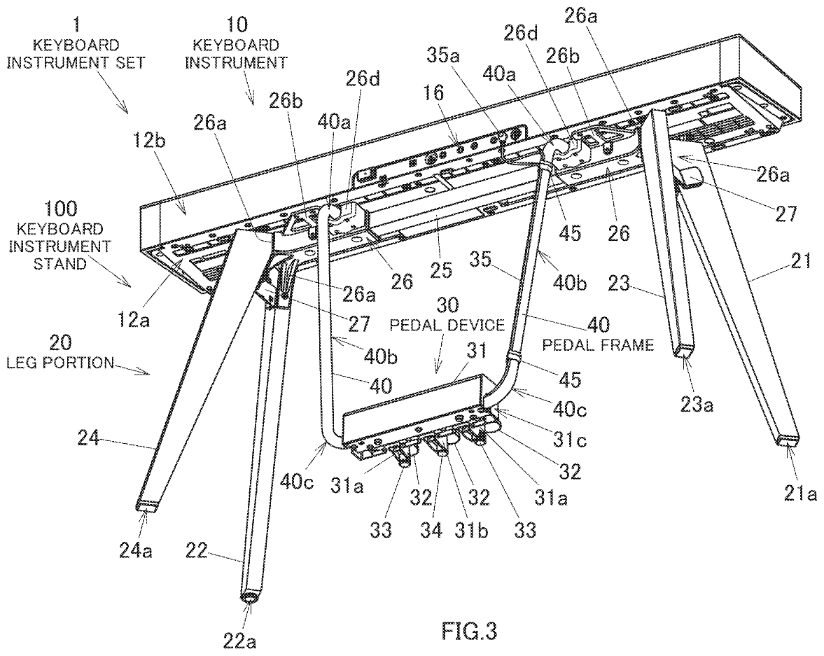

The leg portion 20 for supporting the keyboard instrument 10 includes four legs 21 to 24. In the present embodiment, main parts of the legs 21 to 24 are each made up of a wood member. As shown in FIGS. 2 and 3, the leg portion 20 includes a horizontal spanning member 25 made up of a rectangular parallelepiped hollow member. This horizontal spanning member 25 is disposed underneath a lower surface 12a of the keyboard instrument 10 in such a manner as to extend long in the left-right direction (in other words, extend in the key alignment direction). A connector 26 is provided at each end of the horizontal spanning member 25. Left and right connectors 26 are provided substantially symmetrically.

Each connector 26 includes two leg fixing portions 26a to which the two legs 21, 23 or the two legs 22, 24 are attached. The two legs 21, 23 are attached individually to the two leg fixing portions 26a on the connector 26 on the left side L, and the two leg 22, 24 are attached individually to the two leg fixing portions 26a on the connector 26 on the right side R.

A fixing portion 26b protruding to the back side B is provided on each connector 26. Additionally, a fixing portion 26c protruding to the front side F is also provided on each connector 26. Both the fixing portion 26c on the front side F and the fixing portion 26b on the back side B include abutment surfaces 26c1, 26b1, respectively, which are brought into abutment with the lower surface 12a of the keyboard instrument 10. The abutment surfaces 26c1, 26b1 constitute surfaces which slightly project from the plate-shaped fixing portions 26c, 26b, respectively. Threaded holes are provided individually in the abutment surfaces 26c1, 26b1, and screw members are screwed into female or internally threaded portions (not shown) in the lower surface 12a of the keyboard instrument 10 via the corresponding threaded holes. The horizontal spanning member 25 and each connector 26 define a space between the lower surface 12a of the keyboard instrument 10 and themselves at portions other than the abutment surfaces 26c1, 26b1. Only the abutment surfaces 26c1, 26b1 which include the threaded holes through which the screw members for fixing the keyboard instrument 10 are brought into abutment with the lower surface 12a of the key board instrument 10, whereby beating noise which would be produced when the keyboard instrument 10 is played is mitigated. Additionally, a positioning pin 26c2 is provided on the fixing portion 26c on the front side F in such a manner as to be brought into engagement with an engagement hole portion (not shown) provided in the lower surface 12a of the keyboard instrument 10. A pedal frame fixing portion 26d configured to fix the pedal frame 40, which will be described later, is provided on an inner side of the fixing portion 26b on the back side B.

The legs 21 to 24 each have a rectangular cross-section and are each formed into a shape whose cross-sectional area is gradually reduced towards the lower side Lo. The legs 21 to 24 of the leg portion 20 are provided in such a manner as to expand or lie farther apart from each other as they extend downwards towards the lower side Lo in case viewed not only in the front-back direction FB but also in the left-right direction LR. The legs 21 to 24 include setting foot portions 21a, 22a, 23a, 24a, respectively, which are brought into abutment with a setting floor surface FL. Here, the setting foot portion 22a at a lower end of the right front leg 22 is made into a leg adjuster. The setting foot portion 22a, which functions as the leg adjuster, is configured to adjust the position of an abutment portion with the setting floor surface FL by means of a screw structure or the like. All the setting foot portions 21a, 22a, 23a, 24a may be made into leg adjusters. As a result, tolerances and building variations among the constituent components can be adjusted better.

An angle brace member 27 is provided between the leg 21 and the leg 23 on the left side L to connect the leg 21 and the leg 23 together, and an angle brace member 27 is also provided between the leg 22 and the leg 24 on the right side R to connect the leg 22 and the leg 24 together.

As the pedal frame 40 for connecting the keyboard instrument 10 and the pedal device 30, in total, two pedal frames 40 are provided; one for the left side L and the other for the right side R. In the case that the keyboard instrument 10 and the keyboard instrument stand 100 are fixed to each other, the terminal panel 16 (the data communication portion) is disposed directly above a space defined between inner sides of the two pedal frames 40 (between the two pedal frames 40). Each pedal frame 40 is formed by bending a solid metal rod member and includes an upper end portion 40a, an intermediate portion 40b, and a lower end portion 40c. The upper end portion 40a is provided at an upper end portion of the pedal frame 40 in such a manner as to extend short in the front-back direction FB. The upper end portion 40a is fixed to the pedal frame fixing portion 26d of the connector 26. The intermediate portion 40b is provided in such a manner as to be bent from the upper end portion 40a to extend towards the lower side Lo while being inclined inwards (towards a center of the keyboard instrument set 1). The lower end portion 40c is bent laterally inwards in the left-right direction LR from the intermediate portion 40b to fixedly connect to a left side surface or a right side surface of a pedal device main body 31 (which will be described later) of the pedal device 30.

As shown in FIGS. 1 to 3, the pedal device 30 includes the pedal device main body 31 formed as a rectangular parallelepiped box which is long in the left-right direction LR. The pedal device main body 31 includes three pedals 32, which are aligned in the left-right direction LR in such a manner as to project to the front side F. A projecting portion 31a is provided underneath each of a pedal 32 on the left side L and a pedal 32 on the right side R in such a manner as to extend to the front side F from the pedal device main body 31. A setting adjuster 33 is provided on the projecting portion 31a so as to adjust the abutment with the setting floor surface FL. The setting adjuster 33 is attached to the projecting portion 31a via a screw structure. A pad 34 facing the setting floor surface FL is provided on a projecting portion 31b which extends to the front side F from the pedal device main body 31 on a lower side Lo of a central pedal 32 so as to move towards or come into contact with the setting floor surface FL.

A wiring 35 is provided on a left side surface of the pedal device main body 31 and is laid out along the pedal frame 40 on the left side L while being fixed to the intermediate portion 40b of the relevant pedal frame 40 on the left side L with fixing bands 45 at two locations at the upper side Up and the lower side Lo. A plug 35a of the wiring 35 is inserted into a predetermined terminal in the terminal panel 16 of the keyboard instrument 10 for connection therewith. The keyboard instrument 10 and the pedal device 30 are electrically connected to each other by means of the wiring 35.

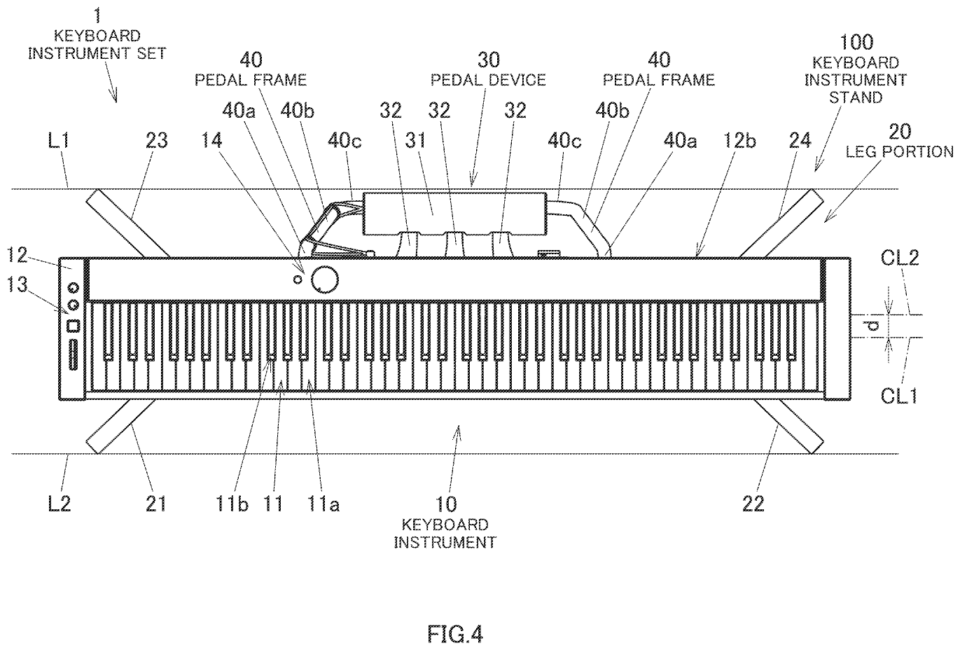

As shown in FIG. 4, both the pedal frame 40 on the left side L and the pedal frame 40 on the right side R include a portion which is disposed further towards the back side B than the back surface 12b of the keyboard instrument 10. That is, the back surface 12b of the keyboard instrument 10 constitutes a backmost end portion in a short direction of the keyboard instrument 10, and at least a part of the pedal frame 40 is disposed further towards the back side B than the backmost end portion in a short direction of the keyboard instrument 10. As a result, even with the mode of the present embodiment in which the keyboard instrument 10 which is relatively short in dimension in the front-back direction FB is supported by the keyboard instrument stand 100 (the leg portion 20), the pedal device 30 can be positioned on a farther side.

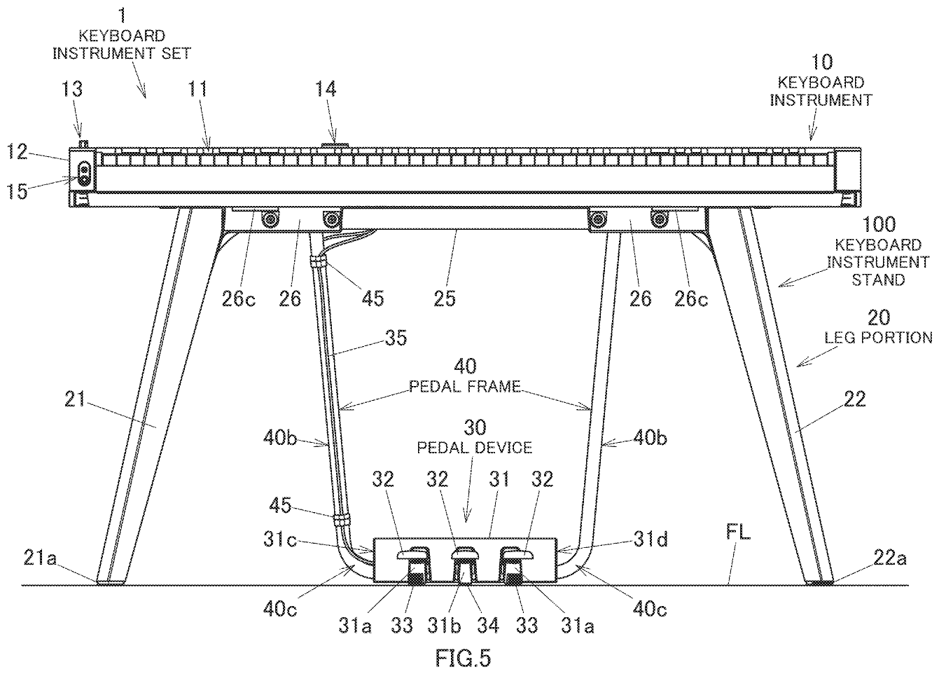

In addition, as shown in FIG. 5, the pedal device main body 31 of the pedal device 30 is disposed further upwards than lower surfaces (that is, the setting floor surface FL) of the setting foot portions 21a to 24a of the legs 21 to 24 of the leg portion 20. Additionally, as has been described before, the intermediate portions 40b of the pedal frames 40 on the left side L and the right side R are inclined laterally inwards. As a result, as viewed from the front-back direction FB, the pedal frames 40 include two rod members (the lower end portions 40c, the intermediate portions 40b) which extend upwards from left and right side portions (a left side portion 31c, a right side portion 31d) of the pedal device main body 31 in such a manner as to define an inverted trapezoidal shape therebetween together.

The pedal frames 40 hold a higher rigidity as a result of including the portions which are disposed in such a manner as to define the inverted trapezoidal shape therebetween when compared with a case in which the pedal frames 40 extend perpendicularly relative to the setting floor surface FL. Further, with the pedal frames 40, as a result of including the portions which are disposed in such a manner as to define the inverted trapezoidal shape therebetween, a large space is provided on the upper side Up, whereby even when the keyboard instrument set 1 is used by the player who sits on a chair, a risk is reduced that the knees of the player interfere with the pedal frames 40.

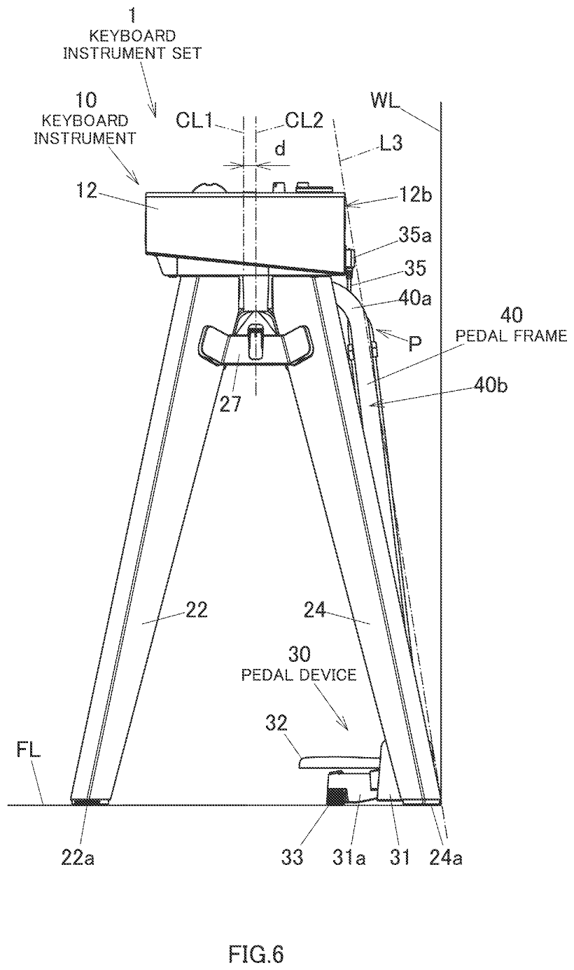

As shown in FIG. 4, the pedal device main body 31 of the pedal device 30 and the pedal frames 40 are disposed further towards the front side F than a line L1 which connects backmost end portions of the two legs 23, 24 on the back side B (back legs) (lower end portions of the legs 23, 24). As a result, even though the keyboard instrument set 1 is inclined towards the back side B, there is no risk that the pedal device 30 (the pedal device main body 31) is brought into abutment with the setting floor surface FL. In addition, as shown in FIG. 6, in the case that the keyboard instrument set 1 is set by the side of a wall, since a wall surface WL matches the line L1 which connects the backmost end portions of the two legs 23, 24 on the back side B, there is no risk that the keyboard instrument 10, the pedal device 30 (the pedal device main body 31), and the pedal frames 40 are brought into abutment with the wall surface WL.

With the pedal device 30, the pedal device main body 31 including the projecting portions 31a, 31b is not set on the setting floor surface FL but is supported in place by the setting adjusters 33 being brought into abutment with the setting floor surface FL. That is, the pedal device main body 31 of the pedal device 30 is positioned further towards the upper side Up than the lower surfaces of the setting foot portions 21a to 24a at the lower ends of the legs 21 to 24. Due to a synergetic effect produced by this configuration and the position of the pedal device 30 in the front-back direction FB, the pedal device 30 (the pedal device main body 31) is prevented from being brought into abutment with the setting floor surface FL even though the keyboard instrument set 1 is inclined backwards.

As shown in FIG. 4, the keyboard instrument 10 is positioned between the line L1 which connects the backmost end portions of the two legs 23, 24 on the back side B and a line L2 which connects frontmost end portions of the two legs 21, 22 on the front side F (lower end portions of the legs 21, 22) in the front-back direction FB. As a result, a risk is reduced that the keyboard instrument set 1 falls down in the front-back direction FB.

As shown in FIGS. 4 and 6, the keyboard instrument 10 is attached to the leg portion 20 in such a manner that a center CL of the keyboard instrument 10 in the front-back direction FB is offset a predetermined distance “d” to the front side F from a center CL2 of the leg portion 20 in the front-back direction FB. As a result, the keyboard instrument 10, which is heavier on the back side B and of which a center of gravity is positioned closer to the back side B in the front-back direction FB, can be supported stably on the leg portion 20.

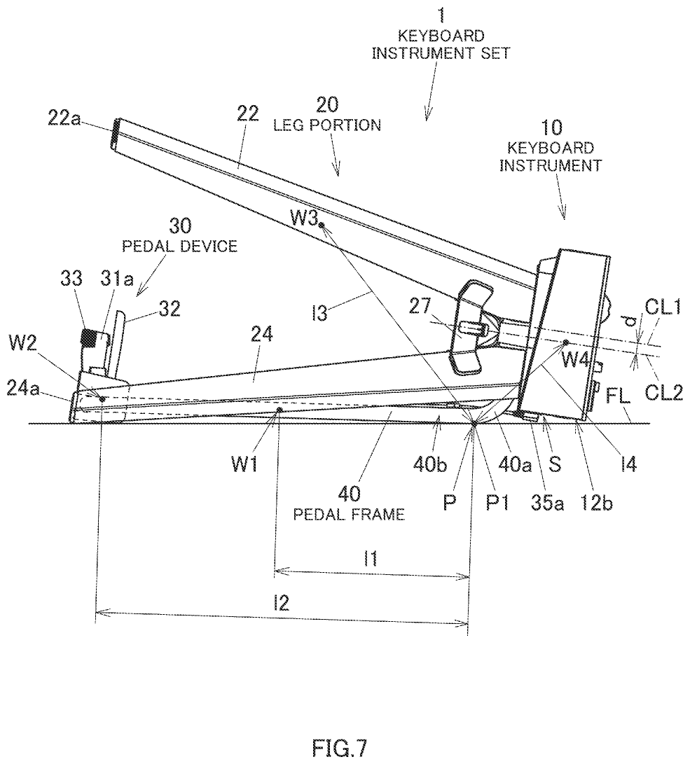

As shown in FIG. 6, which is a side view of the keyboard instrument set 1, an upper end side of the pedal frame 40 (more specifically speaking, a bent connecting portion P where the upper end portion 40a and the intermediate portion 40b are connected together) is disposed further towards the back side B than a line L3 which connects a backmost end of a top surface of the keyboard instrument 10 and a backmost end of the leg 24 (the leg 23) at a lowermost end thereof. In other words, an upper end of the pedal frame 40 is disposed further towards the back side B than an upper end of the leg portion 20 (the legs 23, 24). As shown in FIG. 7, when the keyboard instrument set 1 is disposed in such a manner that the back surface 12b of the keyboard instrument 10 faces the setting floor surface FL, the left, and right pedal frames 40 and the legs 23, 24 on the back side B of the leg portion 20 are brought into abutment with the setting floor surface FL to thereby support the keyboard instrument 10. In other words, the backmost end portions of the legs 23, 24 and the intermediate portion 40b (the connecting portion P) lying in the vicinity of the bent portion where the upper end portion 40a and the intermediate portion 40b are connected together are in abutment with the setting floor surface FL. At this time, a space portion S is provided between the setting floor surface FL and the back surface 12b of the keyboard instrument 10.

While FIG. 7 illustrates the state in which the back surface 12b of the keyboard instrument 10 is disposed in such a manner as to face the setting floor surface FL, even in such a state that the keyboard instrument set 1 is inclined backwards in such a manner that the back surface 12b of the keyboard instrument 10 stays closer to the wall surface WL, the upper ends of the pedal frames 40 come into contact with the wall surface WL, whereby the back surface 12b of the keyboard instrument 10 never comes into contact with the wall surface WL.

Thus, even in the event that the keyboard instrument set 1 falls down to the back side B, a risk is reduced that the keyboard instrument 10 strikes strongly directly against the setting floor surface FL. That is, as shown in FIG. 7, a rotational moment of the keyboard instrument set 1 produced on the connecting portion P where the pedal frames 40 are brought into abutment with the setting floor surface FL as a fulcrum P1 when the keyboard instrument set 1 falls down to the back side B is given by an expression (1) below:

W1×11+W2×12+W3×13>W4×14 (1)

where,
W1: Center of gravity of pedal frame 40;
W2: Center of gravity of pedal device 30;
W3: Centers of gravity of front legs 21, 22;
W4: Center of gravity of keyboard instrument 10; and
11, 12, 13, 14: Distances from fulcrum P1 to centers of gravity W1, W2, W3, W4.
   The back legs 23, 24 also contribute to a rotational moment opposite to the rotational moment W4×14 in connection with the keyboard instrument 10. According to the relationship expressed by the expression (1), even in the event that the keyboard instrument set 1 falls down to the back side B, the side of the pedal device 30 is prevented from being raised, whereby the space portion S is defined.

Further, as a result of the plug 35a being eventually disposed in the space portion S which is defined in the case that the keyboard instrument set 1 is supported by the legs 23, 24 on the back side B and the left, and right pedal frames 40, a risk of the plug and the cord being damaged, a risk of the jack alone being damaged, and a risk of the substrate (the data communication portion) to which the jack is attached being damaged are reduced which would otherwise be caused as a result of the plug 35a which projects from the back surface 12b of the keyboard instrument 10 violently striking against the setting floor surface FL when the keyboard instrument set 1 falls down to the back side B.

The pedal frame 40 is formed of a heavy solid metallic material (more preferably, of a steel material). In addition, the heavy pedal device 30 is provided near to the setting floor surface FL. As a result, even in the event that the keyboard instrument 1 falls down to the back side B as shown in FIG. 7, the setting foot portions 21a to 24a of the legs 21 to 24 are hardly raised upwards by virtue of the provision and arrangement of the heavy pedal frames 40 and pedal device 30 on the keyboard instrument set 1 as described in the present embodiment, while the setting foot portions 21a to 24a of the legs 21 to 24 would otherwise be raised by the reaction of the falling down of the keyboard instrument set 1. Thus, a risk is reduced that the keyboard instrument 10 is caused to violently strike against the setting floor surface FL as a result of deletion of the space portion S due to the setting foot portions 21a to 24a being so raised.

With the keyboard instrument set described in JP-A-2008-3493, in the case of a large keyboard instrument, the pedal device can be disposed in a good position for the player to operate it with his or her foot by securing a sufficient distance towards the farther side from the sitting position of the player below the keyboard instrument. However, in the case of a compact keyboard instrument, in the case that the pedal device is disposed under the keyboard instrument, a distance between the foot of the player and the pedal device is reduced to such an extent that the player has difficulty in operating the pedal device. Although the pedal device can be disposed separately from the keyboard instrument or the leg portion, the keyboard instrument set will be enlarged in size as a whole even though the keyboard instrument can be kept compact in size.

On the other hand, with the embodiment of the present disclosure, the keyboard instrument stand 100 includes the leg portion 20 for supporting the keyboard instrument 10, the pedal device 30, and the pedal frames 40 for fixing the pedal device 30 of which at least the part is disposed further towards the back side B than the backmost end portion in a short direction of the keyboard instrument 10.

As a result, the whole of the keyboard instrument set 1 can be made compact in size while the pedal device 30 is allowed to be disposed in the position which facilitates the depression of the pedals 32 of the pedal device 30 by the player, thereby making it possible to provide the keyboard instrument stand 100 and the keyboard instrument set 1 which have the improved design property and the good operability.

The leg portion 20 is disposed in such a manner as to be expanded outwards of the keyboard instrument 10 in case viewed not only in the front-back direction FB but also in the left-right direction LR, and the upper ends of the pedal frames 40 are disposed further towards the back side B than the upper end of the leg portion 20. As a result, the pedal device 30 and the leg portion 20 are made inconspicuous, and the keyboard instrument 10 looks as if it floats in the air. In addition, the keyboard instrument stand 100 can be provided which makes it difficult for the keyboard instrument 10 to violently strike against the setting floor surface FL even in the event that the keyboard instrument set 1 falls down to the back side B.

The leg portion 20 includes the two back legs (legs 23, 24) which are provided on the back side B, and the pedal device 30 and the pedal frames 40 are disposed further towards the front side F than the line L1 which connects the backmost end portions of the two back legs. As a result, the keyboard instrument set 1 can be disposed in such a manner that the back legs are in abutment with the wall surface WL.

With the keyboard instrument stand 100, in the case that the back surface 12b (the back surface) of the keyboard instrument 10 comes to face the setting floor surface FL as a result of the keyboard instrument set 1 falling down to the back side B, the upper end sides of the pedal frames 40 and the lower end side of the leg portion 20 brought into abutment with the setting floor surface FL, whereby the keyboard instrument 10 is prevented from being brought into abutment with the setting floor surface FL. This defines the space portion S. Thus, even in the event that the keyboard instrument set 1 falls down to the back side B, a risk is reduced that the keyboard instrument 10 violently strikes against the setting floor surface FL, and hence, a risk is reduced that the keyboard instrument 10 is damaged.

In the present embodiment, while the two left and right pedal frames 40 are disposed, a single substantially U-shaped pedal frame may be adopted. Alternatively, another form may be adopted in which three or more pedal frames are provided.

The pedal frames 40 include the two rod members (the lower end portions 40c, the intermediate portions 40b) which extend from the left and right side portions (the left side portion 31c, the right side portion 31d) of the pedal device 30 toward the upper side Up in such a manner as to define the inverted trapezoidal shape therebetween in case viewed from the front side. As a result, the pedal frames 40 can be provided which do not interrupt the operation of the pedal device 30 while improving the rigidity of the pedal frames 40.

The keyboard instrument stand 100 includes the horizontal spanning member 25 which extends in the key alignment direction and the plural connectors 26 which are disposed individually at both the ends of the horizontal spanning member 25. The plural connectors 26 each have the pedal frame fixing portion 26d for fixing the pedal frame 40 and the leg fixing portions 26a for fixing the leg portion 20 (the legs 21 to 24). As a result, the keyboard instrument stand 100 can be provided which is simple in construction and is easy to be built up and which functions well.

The upper end portions 40a of the pedal frames 40 are fixed to the connectors 26 on the back side B of the connectors 26 in case viewed from the player's side. As a result, even with the keyboard instrument stand 100 which is short in length in the front-back direction FB, the pedal device 30 can be disposed in the backward position where the player can easily operate the pedal device 30 for his or her play.

The keyboard instrument set 1 includes the keyboard instrument stand 100. As a result, the good keyboard instrument set 1 can be provided.

The keyboard instrument set 1 includes the data communication portion for communication with external equipment at the central portion on the back surface of the keyboard instrument 10. In the case that the keyboard instrument 10 and the keyboard instrument stand 100 are fixed to each other, the data communication portion is disposed above the space defined inside the pedal frames 40. As a result, even in the event that the keyboard instrument set 1 falls down to the back side, a risk can be reduced that the data communication portion violently strikes against the setting floor surface FL.

While the embodiment of the present disclosure has been described heretofore, the embodiment is presented as the example, and hence, there is no intention to limit the scope of the present invention by the embodiment. The novel embodiment can be carried out in other various forms, and various omissions, replacements and modifications can be made thereto without departing from the spirit and scope of the present invention. Those resulting embodiments and modified examples thereof are included in the scope and gist of the present invention and are also included in the scope of inventions claimed for patent under claims below and their equivalents.

What is claimed is:

1. A keyboard instrument stand comprising:
a leg portion configured to support a keyboard instrument;
a pedal device; and
a pedal frame configured to fix the pedal device of which at least a part is disposed further backwards than a backmost end portion in a short direction of the keyboard instrument.

2. The keyboard instrument stand according to claim 1,
wherein the leg portion is disposed in such a manner as to be expanded outwards of the keyboard instrument in case viewed not only in a front-back direction but also in a left-right direction, and
wherein an upper end of the pedal frame is disposed further toward a back side than an upper end of the leg portion.

3. The keyboard instrument stand according to claim 1,
wherein the leg portion comprises two back legs provided on a back side, and
wherein the pedal device and the pedal frame are disposed further toward a front side than a line which connects backmost end portions of the two back legs.

4. The keyboard instrument stand according to claim 1,
wherein in a case that a back surface of the keyboard instrument comes to face a setting floor surface as a result of the keyboard instrument set falling down to a back side, an upper end side of the pedal frame and a lower end side of the leg portion are brought into abutment with the setting floor surface, and the keyboard instrument is not brought into abutment with the setting floor surface.

5. The keyboard instrument stand according to claim 1,
wherein the pedal frame comprises two rod members which extend from a left and right side portions of the pedal device towards an upper side in such a manner as to define an inverted trapezoidal shape therebetween in case viewed from a front side.

6. The keyboard instrument stand according to claim 1, comprising:
a horizontal spanning member extending in a key alignment direction; and
plural connectors which are disposed individually at both ends of the horizontal spanning member,
wherein each of the plural connectors comprises a pedal frame fixing portion configured to fix the pedal frame and a leg fixing portion configured to fix the leg portion.

7. The keyboard instrument stand according to claim 6,
wherein an upper end portion of the pedal frame is fixed to the connector on a back side of the connector in case viewed from a player's side.

8. A keyboard instrument set, comprising:
the keyboard instrument stand according to claim 1; and
a keyboard instrument.

9. The keyboard instrument set according to claim 8,
wherein a data communication portion for communication with external equipment is provided at a central portion on a back surface of the keyboard instrument, and
wherein the data communication portion is disposed inside the pedal frame in the case that the keyboard instrument and the keyboard instrument stand are fixed to each other.
